(19) United States
(12) Patent Application Publication
(10) Pub. No.: US 2015/0107373 A1
(43) Pub. Date: Apr. 23, 2015

(54) Apparatus and Process for Measuring the Friability of Polymer Bales

(71) Applicants: LANXESS Corporation, Pittsburgh, PA (US); LANXESS Elastomers, B.V., Geleen (NL)

(72) Inventors: Errol OLIVIER, Beaumont, TX (US); Dilipkumar PADLIYA, Beaumont, TX (US); Samuel Douglas STONE, Kirbyville, TX (US); Bruce STONE, Port Arthur, TX (US); Mark KUIJPERS, Maasmechelen (BE)

(21) Appl. No.: 14/520,723

(22) Filed: Oct. 22, 2014

Related U.S. Application Data
(60) Provisional application No. 61/894,587, filed on Oct. 23, 2013.

(51) Int. Cl. B25B 23/142

(52) U.S. Cl. CPC B25B 23/1427
USPC 73/862.21

(57) ABSTRACT

A process for measuring the friability of a material, such as a polymer bale, may include measuring the amount of force required to break-up a portion of the material. A corresponding testing apparatus for measuring the friability may include a device configured for breaking-up the portion of the material and measuring the force required to cause the break-up to occur.

### BACKGROUND

The present invention relates generally to a method of measuring the friability of polymer bails and more particularly relates to a method of measuring the friability of elastomeric polymer bails, such as rubber bales, using a device having a pronged probe which when inserted into a the bale allows for the quantitative measure of such a bale's friability.

Friability generally is a term used in the rubber industry to describe the characteristic of bales of having low compaction, which is useful for easy and fast mixing in internal mixers. Rubber bales, for example, which have a low level of compaction are friable. Rubber bales with a high level of compaction are dense. The level of friability, i.e., the ease by which a bail breaks/tears apart, can vary from nearly dense to a bale which crumbles upon touch.

A need has therefore been recognized in connection with providing a device and method especially useful in measuring friability and, in turn, the ease with which a bale of polymeric material will crumble. Once friability is defined, it can be related to preference for mixing and handling, which in turn may be utilized to set processing conditions. This applies to bales that are intentionally made to break apart easily, for example rubber bales made by controlling the temperature of crystalline grades and/or the use of partitioning agents. The advantage is that in later processes bales which break apart easily require less mixing time and provide faster throughput rates than bales that are difficult to break apart.

Bales may include any type of polymeric material which is capable of forming a bale having a measurable degree of friability. Such materials include, without limit, elastomeric polymers, for example various types of rubber bales. The following are in particular mentioned as elastomeric polymers which contain double bonds and which can be used to form a rubber bale: polyisoprene of synthetic or natural origin (IR and NR), styrene-butadiene rubber (SBR), butadiene rubbers (BR), acrylonitrile-butadiene rubbers (NBR), butyl rubbers (IIR), bromobutyl rubbers (BIIR), chlorobutyl rubbers (CIIR), polychloroprene rubbers, hydrogenated acrylonitrile-butadiene rubbers (HNBR), epoxidized natural rubber (ENR), polynorbornene rubbers, and rubbers based on ethylene-propylene polymers (EPDM), preference being given to EPDM rubber.

### SUMMARY

There is broadly contemplated, in accordance with at least one presently preferred embodiment of the present invention, a process for measuring the friability of a polymer bale, comprising the steps of providing a polymer bale, and measuring the amount of torque required to remove a portion of the polymer bale, wherein the measuring step is performed via a friability testing apparatus. In another embodiment there is a friability testing apparatus comprising a torque wrench having a probe coupled thereto, wherein the probe comprises a probe base, said probe base having a first side and a second side, opposite one another; and at least one prong fixedly attached to said first side of the probe base and at least one coupler fixedly attached to said second side of the probe base, wherein said coupler can be attached to the torque wench.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 shows friability test locations and results for a skid of bales of a first rubber material according to an embodiment.

FIG. 2 shows friability test locations and results for a skid of bales of a second rubber material according to an embodiment.

### DETAILED DESCRIPTION

The present process for measuring the friability of a rubber bale is conducted via a friability testing apparatus. The friability testing apparatus provides a way to break or tear apart a portion of polymer from a polymer bale, whereby, the amount of torque required is measured thus providing the degree of friability of the bale. “Friability” as used herein shall be understood to mean the amount of torque required to loosen, to the extent of being detached, a select portion of polymer from a polymer bale. For quantitative purposes one may define bales needing more than 75 foot-pounds of torque via the friability testing apparatus described herein as non-friable and bales requiring less than 50 foot-pounds torque as friable.

A friability testing apparatus broadly comprises a probe which is attachable to a torque measuring device. In a preferred embodiment of the invention, the friability testing apparatus comprises a probe connectable to a standard torque wrench. A probe having prongs which can penetrate well into the bale and tear it apart is best suited to measure friability. A three-pronged probe is preferred as it cannot be turned without tearing the rubber bale apart.

In one embodiment, the probe comprises a probe base having first and second sides opposed to one another; prongs attached to the first side of the probe base; and a coupler capable of connecting to a torque wrench on the second side. The coupler, in one embodiment, allows for attachment to a ⅜″ drive on a ⅜″ drive adjustable torque wrench. In one embodiment, a 75 foot-lb torque wrench is selected. The wrench can be adjusted to measure various amounts of torque via a torque set point. Once the set torque level is met, an audio or visual notification is provided by the wrench, for example an audible click produced by the torque wrench is common.

In principle, any multipronged probe should be able to break apart a friable bale and provide a quantifiable measurement by the method of this invention. In the preferred embodiment, a three-pronged probe is used. A circular probe based may be used and the prongs arranged around the probe base at positions of 0 degrees, 120 degrees, and 240 degrees, respectively. However, it should be appreciated that this arrangement is not meant to be limiting. For example, a plurality of prongs could be positioned in a straight line. Or a single prong could take a shape capable of tearing the bale. It should be appreciated that variations in the number of prongs, the arrangement of the prongs, and the length of the prongs are possible and, moreover, such options will alter the torque required to break the bale apart—though still providing a quantifiable and reproducible measure of friability. Thus, for reliable reproducibility it is necessary to keep constant the dimensions of the probe once selected for comparative tests.

The length of the prongs needs to be sufficient to penetrate the bale to a depth that provides a representative measure of the overall bale friability. For example, the length of each prong employed in the preferred embodiment is 2.75-3 inches. Such length, however, is also not meant to be limiting.

The prongs may be pointed at the ends so as to allow their insertion into loosely compacted bales with ease. However for consistency, especially when testing more compacted bales, a drilling template can be utilized which allows one to drill holes into the bales to allow for insertion of the prongs into the predrilled holes. Then the probe can be easily pushed into any bale, including a dense one.

In one embodiment, on the side of the probe base opposite from the prongs is a coupler. The coupler is made from an extension for a ⅜ inch drive socket wrench. A torque wrench having a ⅜ inch drive can then be easily attached to such a coupler.

Two torque wrenches have been used for the process. The first is a Craftsman Model 63002 Micro-clicker wrench ranging from 10-75 ft-lbs of torque. The wrench does not give a direct reading of torque, but it can be adjusted in 0.5 lb. increments until the bale breaks, and the breaking torque can be interpolated between torque levels at which the bale did and did not break. The second torque wrench used is an Eastwood ⅜″ Drive Digital Electronic Torque Wrench (Part # 13630) having a torque range from 7-100 ft-lbs. The display on this wrench has an option to measure directly and report the peak torque reached when the wrench is turned.

In at least one embodiment the friability of a rubber bale is tested via a friability testing apparatus in which holes are drilled into the rubber bale, optionally with the aid of a drilling template. The prongs of the probe on a first side are inserted into the drilled holes of the bale such that the probe base first side is then flush with surface of the bale. Then the torque level on the torque wrench is set to a desired level via the torque set point. The torque wrench is attached to the coupler of the second side of the prong base, The wrench can then be operated so as to determine the torque. For example the wrench may be operated until a click is sounded by the wrench indicating the initial torque setting is reached. The level is then increased and the wrench operated again. To judge the torque required to tear the bale one may begin at a low setting and successively increase the setting until the bale tears without sounding the click. The process may be repeated for each of the four corners of the bale and at a point near the center of the bale.

Using the principles and methods illustrated in the examples, and applying them to a great number of bales, a scale that characterizes the level of friability can be set up according to the needs and preferences of the party having an interest in characterization of the friability level of the bale.

### EXAMPLES

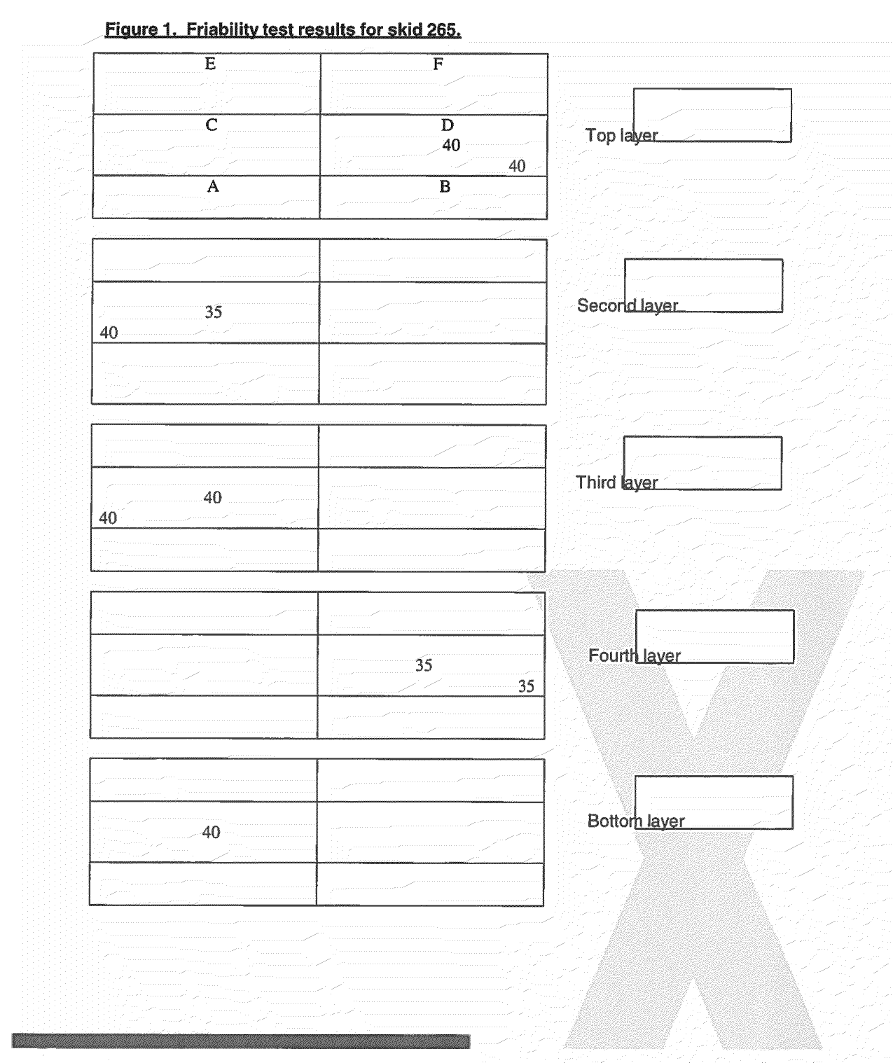

Two skids of rubber bales (5 bales per skid) were measured for friability. FIG. 1 shows the results of skid 265. All the bales could be broken up at torques of 35 or 40 ft-lbs. Also the bales could be broken easily by hand. As such, the test result and visual characterization was that this dearly represents a skid comprising bales having good friability.

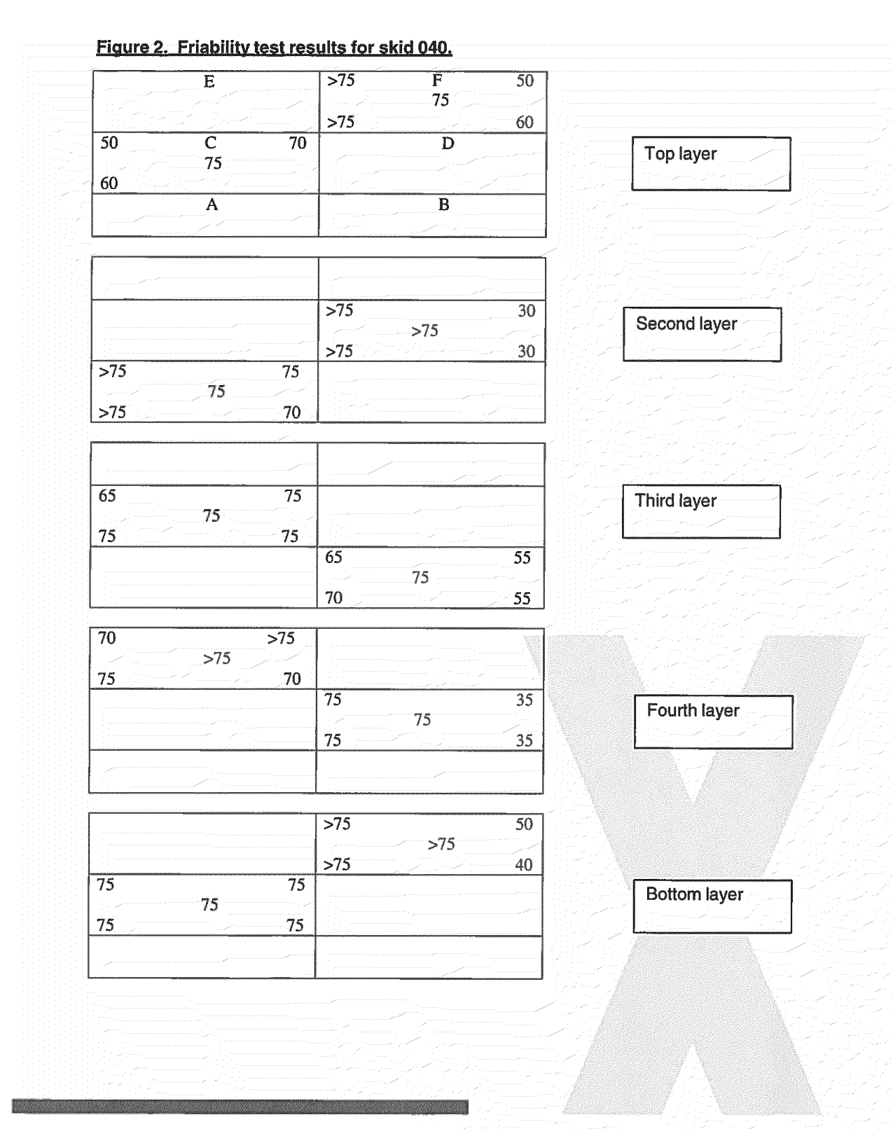

FIG. 2 shows the results of measurements for skid 040. Two features are noted. First many of the torque readings on all levels are 75 ft-lbs or greater. From a pinch test of these bales it was judged that such a bale would not be classified as friable. It was also noted that a number of the bales showed “bi-modal” friability behavior. That is, the friability reading on one end of the bale was much higher than that on the other end of the bale. It was noted specifically to be a feature across the length of the bale. That is, the difference was not noted on opposite ends of the width of the bale.

It can be appreciated, the reproducibility of the friability test will depend upon the accuracy of the torque measurement and the even distribution of density and friability throughout the bales. As indicated above, the torque wrench can be adjusted in 0.5 ft-lb increments. However that may be judged to be more sensitive than is needed or practical. It is recognized that the first attempt to break the bale will in any case loosen the crumb leaving the sample spot slightly disturbed for the next attempt. It is believed that using increments of 5 ft-lbs provides an accuracy that is not affected by successive attempts, In practice for bales that appear to be readily friable, a good starting point is 40 ft-lbs. If the bale breaks on the first attempt, the second test can be performed, at a new spot, at a lower setting. For bales that appear to have questionable friability, 50 ft-lbs might be a good starting point. If the bale fails to break, successive attempts can be made in 5 ft-lb increments until the bale either breaks, or the limit of the torque wrench (75 ft-lbs for this work) is reached. In the case of the bimodal bales it can be seen quite easily that the bale is non-uniform. That is one side clearly appears and feels to be denser, while the other side can appear and feel to be almost crumbly.

Using the data for batch skid 265 as an example, it can be seen that, even without a statistical analysis, the results agree very well within 5 ft-lbs. On most of the individual bales the agreement is even closer. For the intended purpose of setting a limit on friability to describe fitness for use, it is more important to identify the highest torque that the bale needs to break, since this will indicate the potential for mixing problems on a macro-scale. The rubber bales in this instance were based on EPDM rubber.

Although the preferred embodiment of the present invention has been described herein with reference to the accompanying drawings and examples, it is to be understood that the invention is not limited to that precise embodiment, and that various other changes and modifications may be affected therein by one skilled in the art without departing from the scope or spirit of the invention.

What is claimed is:

1. A friability testing apparatus for providing a measurement of friability of a friable material, the apparatus comprising:
a portion for engaging the friable material, the portion for engaging being displaceable relative to the engaged friable material to break apart the engaged friable material upon displacement; and
a measuring device for measuring a minimum force required to displace the portion for engaging, wherein materials of greater friability require less force for displacement of the portion for engaging.

2. The friability testing apparatus according to claim 1, wherein the portion for engaging comprises at least one prong for being inserted into the friable material to engage the friable material, and displacement of the at least one prong after insertion breaks apart the friable material.

3. The friability testing apparatus according to claim 1, wherein the portion for engaging comprises a probe, the probe comprising:
a probe base having a first side and a second side, wherein the first side and the second side are opposite one another; and
at least one prong fixedly attached to the first side of the probe base, the at least one prong configured for being inserted into the friable material to engage the friable material, wherein displacement of the at least one prong after insertion breaks apart the friable material.

4. The friability testing apparatus according to claim 3, wherein the measuring device comprises a portion for displacing the probe base relative to the friable material to displace the at least one prong, and the second side of the probe base comprises a coupler configured for attachment to the portion for displacing.

5. The friability testing apparatus according to claim 3, wherein:
the measuring device comprises a torque wrench; and
the portion for engaging comprises a probe, the probe comprising:
a probe base having a first side and a second side, wherein the first side and the second side are opposite one another;
at least two spaced apart prongs fixedly attached to the first side of the probe base, the at least two prongs configured for being inserted into the friable material to engage the friable material, wherein displacement of the at least two prongs after insertion breaks apart the friable material; and
at least one coupler configured for attaching the torque wrench with the second side of the probe base for rotational displacement of the probe base relative to friable material.

6. The friability testing apparatus according to claim 5, wherein:
the probe base is disc-shaped and defines a center point with a circumferential portion disposed about the center point;
the at least two spaced apart prongs comprise three spaced apart prongs disposed in a spaced apart relationship about the circumferential portion at about 120° from one another; and
the at least one coupler is configured to attach the torque wrench to the center point of the probe base.

7. A process for measuring the friability of a polymer bale, the process comprising:
engaging the polymer bale with a device configured to break apart the polymer bale; and
measuring a minimum force needed break apart the polymer bale.

8. A process for measuring the friability of a polymer bale with the testing apparatus of claim 1, the process comprising the steps of:
engaging the portion for engaging with the polymer bale,
displacing the portion for engaging to tear apart a portion of the polymer bale, and
measuring the minimum force required for displacement of the portion for engaging.

9. A process for measuring the friability of a polymer bale with the testing apparatus of claim 5, the process comprising the steps of:
inserting the at least two spaced apart prongs into the polymer bale;
attaching the torque wrench to the probe base;
applying a force to the torque wrench to rotate the at least two spaced apart prongs and tear up the polymer bale; and
measuring the minimum torque required to rotate the at least two spaced apart prongs.
